(19) United States
(12) Patent Application Publication
(10) Pub. No.: US 2017/0214512 A1
(43) Pub. Date: Jul. 27, 2017

(54) CO-FREQUENCY AND CO-TIME FULL DUPLEX TERMINAL FOR RECEIVING AND TRANSMITTING SIGNAL USING COMMON ANTENNA AND COMMUNICATION METHOD THEREOF

(71) Applicant: HuiZhou TCL Mobile Communication Co., Ltd, HuiZhou (CN)

(72) Inventors: Shenggang HU, HuiZhou (CN); Aiping George GUO, HuiZhou (CN); Shiqing ZHAO, HuiZhou (CN)

(21) Appl. No.: 15/327,034

(22) PCT Filed: Apr. 7, 2016
(86) PCT No.: PCT/CN2016/078646

§ 371 Date: Jan. 18, 2017

(30) Foreign Application Priority Data
Aug. 6, 2015 (CN) 201510476488.X

(51) Int. Cl. H04L 5/14; H04B 1/00; H04B 1/48

(52) U.S. Cl. CPC H04L 5/1461; H04B 1/48; H04B 1/0057; H04L 5/143

(57) ABSTRACT

A co-frequency and co-time full duplex terminal for receiving and transmitting a signal using a common antenna and communication method thereof are described. The terminal includes a transmitting unit for amplifying a power of the radio frequency signal to generate a transmitting signal and for transmitting the transmitting signal to the antenna of the antenna unit, an antenna unit for receiving a base station signal where the received base station signal is combined to a self-interference signal to generate a combining signal, and a receiving unit for adjusting the transmitting signal to generate a sampling signal, where the receiving unit delays the combining signal so that the delayed combining signal is mixed to the sampling signal to cancel an interference component.

### BACKGROUND OF THE INVENTION

### Field of Invention

The present invention relates to a technical field of communication, and more particularly to a co-frequency and co-time full duplex terminal for receiving and transmitting a signal using a common antenna and communication method thereof.

### Description of Prior Art

A wireless communication apparatus having a co-frequency and co-time full duplex (CCFD) terminal utilizes the same time and frequency for synchronously transmitting and receiving a wireless signal so that the frequency spectrum efficiency of a wireless communication link is doubled.

Conventionally, an antenna of CCFD terminal of fifth generation (5G) communication apparatus technique employs multiple antenna schemes to cancel antenna interference and radio frequency interference by a plurality of antennas. Since the multiple antennas are used in a higher cost and it is required to prepare an enough space to place the terminal by a specific arrangement of the antennas, such as the antenna arrangement for implementing the mutual cancellation of the antennas, it results in a lot of difficulties of the terminal design, which increases manufacturing cost and the enlarges the volume of the terminal. Meanwhile, a transmitting signal of a CCFD transmitter makes a self-interference signal to a local receiver. Thus, it is required to first cancel the self-interference signal. However, the cancellation of the self-interference signal affects the communication quality of the CCFD terminal.

The present invention provides a co-frequency and co-time full duplex terminal for receiving and transmitting a signal using a common antenna so that the self-interference signal is canceled by the co-frequency and co-time full duplex terminal for receiving and transmitting the signal using the common antenna.

Consequently, there is a need to improve the conventional technique.

### SUMMARY OF THE INVENTION

Based on the above-mentioned drawbacks, one objective of the present invention is to provide a co-frequency and co-time full duplex terminal for receiving and transmitting a signal using a common antenna and communication method thereof so that a transmission and a receipt of CCFD utilizes a common antenna to cancel a self-interference signal.

For the above-mentioned objective, the present invention employs the following technical schemes.

A co-frequency and co-time full duplex terminal for receiving and transmitting a signal using a common antenna includes a central processing unit and a radio frequency transmitter/receiver, where the co-frequency and co-time full duplex terminal further includes a transmitting unit, a receiving unit, an antenna unit having an antenna, and a combiner, where a first end of the combiner couples to the transmitting unit, a second end of the combiner couples to the receiving unit, and a third end of the combiner couples to the antenna;

where a radio frequency transmitter/receiver modulates a transmission data transferred by the central processing unit to form a radio frequency signal, and the transmitting unit amplifies a power of the radio frequency signal to generate a transmitting signal and transmits the transmitting signal to the antenna of the antenna unit;

where the antenna unit receives a base station signal and the received base station signal is combined to a self-interference signal to generate a combining signal;

where the receiving unit adjusts an amplitude and a phase of the transmitting signal to generate a sampling signal, the receiving unit delays the combining signal so that the delayed combining signal is mixed to the sampling signal to cancel an interference component in order to generate a receiving signal, and the radio frequency transmitter/receiver demodulates the receiving signal for transferring the receiving signal to the central processing unit; and

where the transmitting unit is a power amplifier, the combiner transmits the transmitting signal to the antenna for transmission, and the combiner combines the base station signal to the self-interference signal to generate the combining signal for outputting the combining signal to the receiving unit.

In the co-frequency and co-time full duplex terminal for receiving and transmitting the signal using the common antenna, the receiving unit further includes a delay unit, an adjustable decaying unit, an adjustable phase shift unit, and a signal mixer;

where the delay unit delays the combining signal to generate a delay signal;

where the adjustable decaying unit decays an amplitude of the transmitting signal to generate a decayed signal;

where the adjustable phase shift unit makes a phase shift of the decayed signal to generate a sampling signal; and

where the signal mixer mixes the sampling signal to the delay signal to cancel the self-interference signal to output the receiving signal.

In the co-frequency and co-time full duplex terminal for receiving and transmitting the signal using the common antenna, the amplitude of the sampling signal is the same as the amplitude of the self-interference signal.

In the co-frequency and co-time full duplex terminal for receiving and transmitting the signal using the common antenna, the phase of the sampling signal is inverse to the phase of the self-interference signal.

In the co-frequency and co-time full duplex terminal for receiving and transmitting the signal using the common antenna, a phase difference between of the sampling signal and the self-interference signal is π.

In the co-frequency and co-time full duplex terminal for receiving and transmitting the signal using the common antenna, the central processing unit further controls an amplitude adjustment of the adjustable decaying unit and a phase adjustment of the adjustable phase shift unit in a real-time.

A co-frequency and co-time full duplex terminal for receiving and transmitting a signal using a common antenna includes a central processing unit and a radio frequency transmitter/receiver, where the co-frequency and co-time full duplex terminal further includes a transmitting unit, a receiving unit, and an antenna unit having an antenna;

where a radio frequency transmitter/receiver modulates a transmission data transferred by the central processing unit to form a radio frequency signal, and the transmitting unit amplifies a power of the radio frequency signal to generate a transmitting signal and transmits the transmitting signal to the antenna of the antenna unit;

where the antenna unit receives a base station signal and the received base station signal is combined to a self-interference signal to generate a combining signal; and

where the receiving unit adjusts an amplitude and a phase of the transmitting signal to generate a sampling signal, the receiving unit delays the combining signal so that the delayed combining signal is mixed to the sampling signal to cancel an interference component in order to generate a receiving signal, and the radio frequency transmitter/receiver demodulates the receiving signal for transferring the receiving signal to the central processing unit.

In the co-frequency and co-time full duplex terminal for receiving and transmitting the signal using the common antenna, the co-frequency and co-time full duplex terminal further includes a combiner, where a first end of the combiner couples to the transmitting unit, a second end of the combiner couples to the receiving unit, and a third end of the combiner couples to the antenna, and where the combiner transmits the transmitting signal to the antenna for transmission, and the combiner combines the base station signal to the self-interference signal to generate the combining signal for outputting the combining signal to the receiving unit.

In the co-frequency and co-time full duplex terminal for receiving and transmitting the signal using the common antenna, the receiving unit further includes a delay unit, an adjustable decaying unit, an adjustable phase shift unit, and a signal mixer;

where the delay unit delays the combining signal to generate a delay signal;

where the adjustable decaying unit decays an amplitude of the transmitting signal to generate a decayed signal;

where the adjustable phase shift unit makes a phase shift of the decayed signal to generate a sampling signal; and

where the signal mixer mixes the sampling signal to the delay signal to cancel the self-interference signal to output the receiving signal.

In the co-frequency and co-time full duplex terminal for receiving and transmitting the signal using the common antenna, the amplitude of the sampling signal is the same as the amplitude of the self-interference signal, the phase of the sampling signal is inverse to the phase of the self-interference signal, and a phase difference between of the sampling signal and the self-interference signal is π.

In the co-frequency and co-time full duplex terminal for receiving and transmitting the signal using the common antenna, the central processing unit further controls an amplitude adjustment of the adjustable decaying unit and a phase adjustment of the adjustable phase shift unit in a real-time.

In the co-frequency and co-time full duplex terminal for receiving and transmitting the signal using the common antenna, the transmitting unit is a power amplifier.

A communication method of the co-frequency and co-time full duplex terminal for receiving and transmitting the signal using the common antenna, the communication method includes:

modulating, by a radio frequency transmitter/receiver, a transmission data transferred by the central processing unit to form a radio frequency signal;

amplifying, by the transmitting unit, a power of the radio frequency signal to generate a transmitting signal and transmitting the transmitting signal to the antenna of the antenna unit;

receiving, by the antenna unit, a base station signal where the received base station signal is combined to a self-interference signal to generate a combining signal;

adjusting, by the receiving unit, an amplitude and a phase of the transmitting signal to generate a sampling signal, and delaying, by the receiving unit, the combining signal so that the delayed combining signal is mixed to the sampling signal to cancel an interference component for transferring the receiving signal; and

demodulating, by the radio frequency transmitter/receiver, the receiving signal for transferring the receiving signal to the central processing unit.

In the communication method of the co-frequency and co-time full duplex terminal for receiving and transmitting the signal using the common antenna, where adjusting, by the receiving unit, an amplitude and a phase of the transmitting signal to generate a sampling signal, and delaying, by the receiving unit, the combining signal so that the delayed combining signal is mixed to the sampling signal to cancel an interference component for transferring the receiving signal, further includes:

delaying the combining signal to generate a delay signal;

decaying, by the receiving unit, an amplitude of the transmitting signal to generate a decayed signal;

making a phase shift of the decayed signal to generate a sampling signal;

mixing the sampling signal to the delay signal to cancel the self-interference signal to output the receiving signal; and

transferring the receiving signal to the radio frequency transmitter/receiver.

In the communication method of the co-frequency and co-time full duplex terminal for receiving and transmitting the signal using the common antenna, where the amplitude of the sampling signal is the same as the amplitude of the self-interference signal, the phase of the sampling signal is inverse to the phase of the self-interference signal, and a phase difference between of the sampling signal and the self-interference signal is π.

The present invention includes the advantages as follows. the present invention provides a co-frequency and co-time full duplex terminal for receiving and transmitting a signal using a common antenna and communication method thereof to solve the problems of high cost and antenna placement. Meanwhile, by delaying the mixing signal, the amplitude and phase of the transmitting signal are adjusted so that the self-interference signal and the sampling signal in the mixing signal has the same amplitude, an inverses phase and a phase difference π to cancel the self-interference component to assure a better communication quality. The amplitude adjustment of the adjustable decaying unit and the phase adjustment of the adjustable phase shift unit can be controlled in a real-time manner to optimize the performance of the cancellation of the self-interference signal.

### BRIEF DESCRIPTION OF THE DRAWINGS

FIG. 1 is a schematic block diagram of a co-frequency and co-time full duplex terminal for receiving and transmitting a signal using a common antenna according to one embodiment of the present invention;

FIG. 2 is an exemplary diagram of the co-frequency and co-time full duplex terminal for receiving and transmitting the signal using the common antenna according to one embodiment of the present invention; and

FIG. 3 is a flow chart of a communication method of the co-frequency and co-time full duplex terminal for receiving and transmitting the signal using the common antenna according to one embodiment of the present invention according to one embodiment of the present invention.

### DETAILED DESCRIPTION OF THE PREFERRED EMBODIMENTS

The present invention provides a co-frequency and co-time full duplex terminal for receiving and transmitting a signal using a common antenna and a communication method thereof. The transmission and receipt of the co-frequency and co-time full duplex terminal utilizes a common antenna. In other words, a transmission channel and a receipt channel are coupled to the common antenna by a combiner. A delay unit is disposed in the receipt channel to make a time delay synchronization of a self-interference signal and a sampling signal. Furthermore, an amplitude adjustment and a phase adjustment of a sampling channel are controlled in real-time based on a received signal so that the performance of a self-interference signal cancellation is improved. CCFD technique is an optional key technique of 5G communication technical filed. The present invention improves the conventional CCFD technique. The following embodiments refer to the accompanying drawings for exemplifying specific implementable embodiments of the present invention. It should be noted that the exemplary described embodiments are used to describe and understand the present invention, but the present invention is not limited thereto.

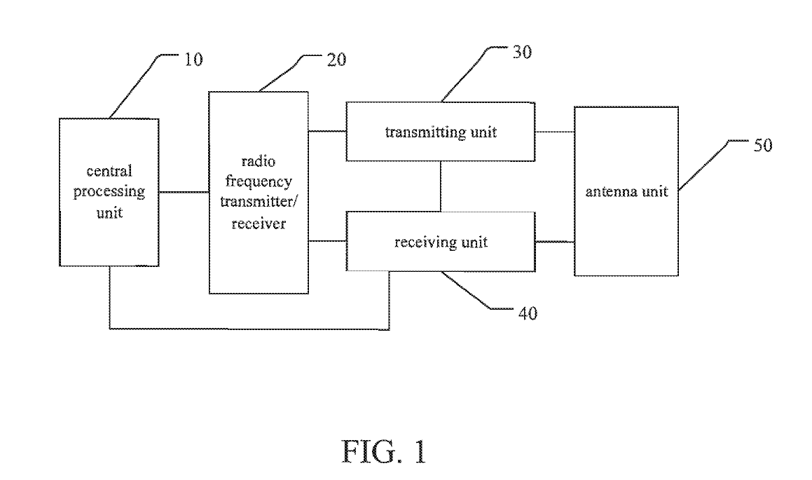

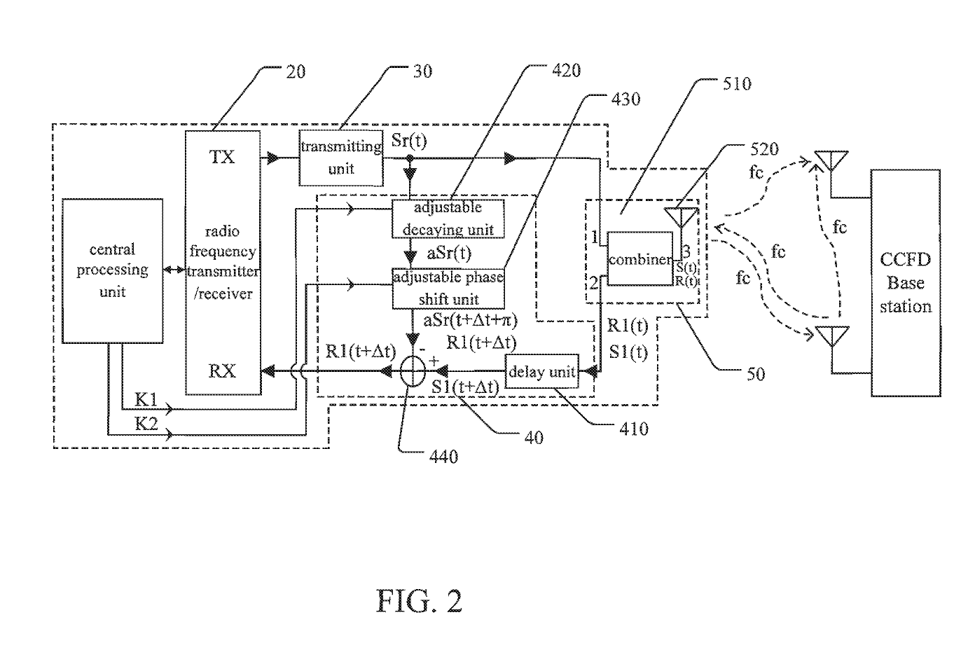

Please refer to FIG. 1 and FIG. 2, which are a co-frequency and co-time full duplex terminal for receiving and transmitting a signal using a common antenna, and a CCFD base station for a communication. The co-frequency and co-time full duplex terminal includes a central processing unit 10, a radio frequency transmitter/receiver 20, a transmitting unit 30, a receiving unit 40, and an antenna unit 50. The central processing unit 10 is coupled to the radio frequency transmitter/receiver 20. The transmitting unit 30 is coupled to the radio frequency transmitter/receiver 20 and the antenna unit 50. The receiving unit 40 is coupled to the radio frequency transmitter/receiver 20 and the antenna unit 50. The antenna unit 50 includes an antenna.

The central processing unit 10 transfers a transmission data to the radio frequency transmitter/receiver 20. The radio frequency transmitter/receiver 20 modulates the transmission data to form a radio frequency signal and outputs the radio frequency signal via a TX port. The transmitting unit 30 makes a power amplification of the radio frequency signal and transmits a transmitting signal Sr(t) having a frequency fc to the antenna unit 50 to be transferred to the CCFD base station.

The antenna unit 50 receives a base station signal R(t) having a frequency fc and transmitted by the CCFD base station where the base station signal R(t) is combined to a self-interference signal to generate a combining signal. On one hand, the receiving unit 40 decays the transmitting signal Sr(t) and makes a phase shift to generate a sampling signal aSr(t+Δt+π) and on the other hand, after the receiving unit 40 delays the combining signal, the delayed combining signal is mixed to the sampling signal aSr(t+Δt+π) to cancel the interference component in order to generate a receiving signal R1(t+Δt) where the receiving signal R1(t+Δt) is outputted to a RX port of the radio frequency transmitter/receiver 20. The radio frequency transmitter/receiver 20 demodulates the receiving signal R1(t+Δt) to be transferred to the central processing unit 10.

In one embodiment, the transmitting unit 30 is a power amplifier. The receiving unit 40 includes a delay unit 410, an adjustable decaying unit 420, an adjustable phase shift unit 430 and a signal mixer 440. The antenna unit 50 includes a combiner 510 and an antenna 520. In one embodiment of the present invention, a transmission channel is defined from the TX port of the radio frequency transmitter/receiver 20 to the first end of the combiner 510 via the transmitting unit 30, and a receipt channel is defined from the second end of the combiner 510 to the RX port of the radio frequency transmitter/receiver 20 via the delay unit 410 and the signal mixer 440. The sampling channel is defined from the output end of the transmitting unit 30 to the negative input end of the signal mixer 440 via the adjustable decaying unit 420 and the adjustable phase shift unit 430.

To solve the problems of high cost, design difficulties and terminal volume of conventional multiple antenna of CCFD terminal, the transmission channel and receipt channel of the CCFD terminal of the present invention utilize a common antenna 520. The third end of the combiner 510 is coupled to the common antenna 520. The first end of the combiner 510 is coupled to the output port of the transmitting unit 30. The second end of the combiner 510 is coupled to the input port of the input port of the delay unit 410. The input port of the transmitting unit 30 is coupled to the TX port of the radio frequency transmitter/receiver 20. The output port of the delay unit 410 is coupled to the positive end of the signal mixer 440. The adjustable decaying unit 420 is coupled to the output port of the transmitting unit 30, the adjustable phase shift unit 430, the central processing unit 10 and the antenna unit 50. The adjustable phase shift unit 430 is coupled to the negative end of the signal mixer 440 and the central processing unit 10. The output port of the signal mixer 440 is coupled to the RX port of the radio frequency transmitter/receiver 20.

The transferring signal transmitted by a channel CH of the antenna 520 includes a transmitting signal S(t) and a base station signal R(t) where the channel CH is defined as the channel between the third end of the combiner 510 and the common antenna 520. In other words, CH=S(t)+R(t). The combining signal outputted by the second end of the combiner 510 includes a first base station signal R1(t) and a self-interference signal S1(t) where the first base station signal R1(t) is received by the common antenna 520 and pass the combiner 510, and the self-interference signal S1(t) includes a transmission signal outputted from the transmitting unit 30 to the combiner 510 and/or a signal inputted to the receipt channel from the common antenna 520. In other words, a signal transferred between the combiner 510 and the delay unit 410 is defined as CH1=R1(t)+S1(t).

The delay unit 410 delays the combining signal (i.e., the first base station signal R1(t) and the self-interference signal S1(t)) to generate a delay signal [R1(t+Δt)+S1(t+Δt)]. The delay manner is configured to implement the time delay synchronization between the self-interference signal and the first base station signal in the receipt channel.

The adjustable decaying unit 420 decays the amplitude of the transmitting signal Sr(t) to generate a decayed signal aSr(t). The adjustable phase shift unit 430 makes a phase shift of the decayed signal aSr(t) to generate a sampling signal aSr(t+Δt+π). The signal mixer 440 mixes the sampling signal aSr(t+Δt+π) to the delay signal [R1(t+Δt)+S1(t+Δt)] to cancel the self-interference signal to output a receiving signal R1(t+≢t).

To cancel the self-interference of the mixed signal between the receipt channel and the sampling channel, the self-interference signal S1(t+Δt) of the delay signal and the sampling signal aSr(t+Δt+π) can be mutually balanced off and no redundant signal. Thus, the decayed and phase shift manner is configured to equalize the amplitude of the sampling signal aSr(t+Δt+π) to the amplitude of the self-interference signal, to make an inverses phase and forms a phase difference π. The mixed result of self-interference signal S1(t+Δt) and the sampling signal aSr(t+Δt+π) is represented by the following formula: S1(t+Δt)+aSr(t+Δt+π)=S1(t+Δt)−aSr(t+Δt)=0. Therefore, the mixed result of the delay signal and the sampling signal is represented by the following formula: R1(t+Δt)+S1(t+Δt)+aSr(t+Δt+π)=R1(t+Δt). Thus, after the signal mixer 440 mixes the signal, the self-interference signal S1(t+Δt) is canceled by the sampling signal aSr(t+Δt+π), and a real receiving data is the receiving signal R1(t+Δt) to achieve the purpose of canceling the self-interference signal for implementing a CCFD communication.

The receiving signal R1(t+Δt) is transmitted to the RX port of the radio frequency transmitter/receiver 20. The radio frequency transmitter/receiver 20 demodulates the receiving signal R1(t+Δt) and transfers the modulated receiving signal R1(t+Δt) to the central processing unit 10. The central processing unit 10 controls the amplitude of the sampling channel and adjusts the phase of the sampling channel to optimize the performance of the cancellation of the self-interference signal.

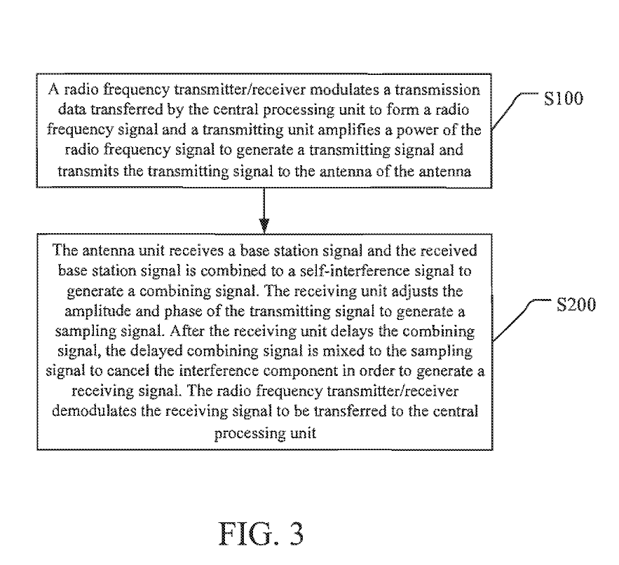

Based on the co-frequency and co-time full duplex terminal for receiving and transmitting the signal using the common antenna in the above-mentioned descriptions, the present invention further provides a communication method of the co-frequency and co-time full duplex terminal for receiving and transmitting the signal using the common antenna. Referring to FIG. 3, the communication method includes the following steps.

In the step S100, a radio frequency transmitter/receiver modulates a transmission data transferred by the central processing unit to form a radio frequency signal. A transmitting unit amplifies a power of the radio frequency signal to generate a transmitting signal and transmits the transmitting signal to the antenna of the antenna.

In the step S200, the antenna unit receives a base station signal and the received base station signal is combined to a self-interference signal to generate a combining signal. The receiving unit adjusts the amplitude and phase of the transmitting signal to generate a sampling signal. After the receiving unit delays the combining signal, the delayed combining signal is mixed to the sampling signal to cancel the interference component in order to generate a receiving signal. The radio frequency transmitter/receiver demodulates the receiving signal to be transferred to the central processing unit.

The step S200 further includes the following steps.

In the step S201, the antenna unit receives the base station signal and the base station signal is combined to the self-interference signal to generate the combining signal.

In the step S202, the receiving unit decays the amplitude of the transmitting signal to generate a decayed signal.

In the step S203, the phase of the decayed signal is shifted to generate the sampling signal.

In the step S204, the sampling signal is mixed to the delay signal to cancel the self-interference and the receiving signal is outputted and transmitted to the radio frequency transmitter/receiver.

In the step S205, after the radio frequency transmitter/receiver demodulates the receiving signal, the radio frequency transmitter/receiver transfers the demodulated receiving signal to the central processing unit.

According to the above-mentioned descriptions, the present invention provides a co-frequency and co-time full duplex terminal for receiving and transmitting a signal using a common antenna and communication method thereof to solve the problems of high cost and antenna placement. Meanwhile, by delaying the mixing signal, the amplitude and phase of the transmitting signal are adjusted so that the self-interference signal and the sampling signal in the mixing signal has the same amplitude, an inverses phase and a phase difference π to cancel the self-interference component to assure a better communication quality. The amplitude adjustment of the adjustable decaying unit and the phase adjustment of the adjustable phase shift unit can be controlled in a real-time manner to optimize the performance of the cancellation of the self-interference signal.

As is understood by a person skilled in the art, the foregoing preferred embodiments of the present invention are illustrative rather than limiting of the present invention. It is intended that they cover various modifications and similar arrangements be included within the spirit and scope of the present invention, the scope of which should be accorded the broadest interpretation so as to encompass all such modifications and similar structures.

1. A co-frequency and co-time full duplex terminal for receiving and transmitting a signal using a common antenna, comprising a central processing unit and a radio frequency transmitter/receiver, wherein the co-frequency and co-time full duplex terminal further comprises a transmitting unit, a receiving unit, an antenna unit having an antenna, and a combiner, wherein a first end of the combiner couples to the transmitting unit, a second end of the combiner couples to the receiving unit, and a third end of the combiner couples to the antenna;
wherein the radio frequency transmitter/receiver modulates a transmission data transferred by the central processing unit to form a radio frequency signal, and the transmitting unit amplifies a power of the radio frequency signal to generate a transmitting signal and transmits the transmitting signal to the antenna of the antenna unit;
wherein the antenna unit receives a base station signal and the received base station signal is combined to a self-interference signal to generate a combining signal;
wherein the receiving unit adjusts an amplitude and a phase of the transmitting signal to generate a sampling signal, the receiving unit delays the combining signal so that the delayed combining signal is mixed to the sampling signal to cancel an interference component in order to generate a receiving signal, and the radio frequency transmitter/receiver demodulates the receiving signal for transferring the receiving signal to the central processing unit; and
wherein the transmitting unit is a power amplifier, the combiner transmits the transmitting signal to the antenna for transmission, and the combiner combines the base station signal to the self-interference signal to generate the combining signal for outputting the combining signal to the receiving unit.

2. The co-frequency and co-time full duplex terminal for receiving and transmitting the signal using the common antenna of claim 1, wherein the receiving unit further comprises a delay unit, an adjustable decaying unit, an adjustable phase shift unit, and a signal mixer;
wherein the delay unit delays the combining signal to generate a delay signal;
wherein the adjustable decaying unit decays an amplitude of the transmitting signal to generate a decayed signal;
wherein the adjustable phase shift unit makes a phase shift of the decayed signal to generate a sampling signal; and
wherein the signal mixer mixes the sampling signal to the delay signal to cancel the self-interference signal to output the receiving signal.

3. The co-frequency and co-time full duplex terminal for receiving and transmitting the signal using the common antenna of claim 2, wherein the amplitude of the sampling signal is the same as the amplitude of the self-interference signal.

4. The co-frequency and co-time full duplex terminal for receiving and transmitting the signal using the common antenna of claim 2, wherein the phase of the sampling signal is inverse to the phase of the self-interference signal.

5. The co-frequency and co-time full duplex terminal for receiving and transmitting the signal using the common antenna of claim 4, wherein a phase difference between of the sampling signal and the self-interference signal is π.

6. The co-frequency and co-time full duplex terminal for receiving and transmitting the signal using the common antenna of claim 2, wherein the central processing unit further controls an amplitude adjustment of the adjustable decaying unit and a phase adjustment of the adjustable phase shift unit in a real-time.

7. A co-frequency and co-time full duplex terminal for receiving and transmitting a signal using a common antenna, comprising a central processing unit and a radio frequency transmitter/receiver, wherein the co-frequency and co-time full duplex terminal further comprises a transmitting unit, a receiving unit, and an antenna unit having an antenna;
wherein a radio frequency transmitter/receiver modulates a transmission data transferred by the central processing unit to form a radio frequency signal, and the transmitting unit amplifies a power of the radio frequency signal to generate a transmitting signal and transmits the transmitting signal to the antenna of the antenna unit;
wherein the antenna unit receives a base station signal and the received base station signal is combined to a self-interference signal to generate a combining signal; and
wherein the receiving unit adjusts an amplitude and a phase of the transmitting signal to generate a sampling signal, the receiving unit delays the combining signal so that the delayed combining signal is mixed to the sampling signal to cancel an interference component in order to generate a receiving signal, and the radio frequency transmitter/receiver demodulates the receiving signal for transferring the receiving signal to the central processing unit.

8. The co-frequency and co-time full duplex terminal for receiving and transmitting the signal using the common antenna of claim 7, wherein the co-frequency and co-time full duplex terminal further comprises a combiner, wherein a first end of the combiner couples to the transmitting unit, a second end of the combiner couples to the receiving unit, and a third end of the combiner couples to the antenna, and wherein the combiner transmits the transmitting signal to the antenna for transmission, and the combiner combines the base station signal to the self-interference signal to generate the combining signal for outputting the combining signal to the receiving unit.

9. The co-frequency and co-time full duplex terminal for receiving and transmitting the signal using the common antenna of claim 8, wherein the receiving unit further comprises a delay unit, an adjustable decaying unit, an adjustable phase shift unit, and a signal mixer;
wherein the delay unit delays the combining signal to generate a delay signal;
wherein the adjustable decaying unit decays an amplitude of the transmitting signal to generate a decayed signal;
wherein the adjustable phase shift unit makes a phase shift of the decayed signal to generate a sampling signal; and
wherein the signal mixer mixes the sampling signal to the delay signal to cancel the self-interference signal to output the receiving signal.

10. The co-frequency and co-time full duplex terminal for receiving and transmitting the signal using the common antenna of claim 9, wherein the amplitude of the sampling signal is the same as the amplitude of the self-interference signal, the phase of the sampling signal is inverse to the phase of the self-interference signal, and a phase difference between of the sampling signal and the self-interference signal is π.

11. The co-frequency and co-time full duplex terminal for receiving and transmitting the signal using the common antenna of claim 9, wherein the central processing unit further controls an amplitude adjustment of the adjustable decaying unit and a phase adjustment of the adjustable phase shift unit in a real-time.

12. The co-frequency and co-time full duplex terminal for receiving and transmitting the signal using the common antenna of claim 7, wherein the transmitting unit is a power amplifier.

13. A communication method of the co-frequency and co-time full duplex terminal for receiving and transmitting the signal using the common antenna of claim 7, the communication method comprising:
modulating, by a radio frequency transmitter/receiver, a transmission data transferred by the central processing unit to form a radio frequency signal;
amplifying, by the transmitting unit, a power of the radio frequency signal to generate a transmitting signal and transmitting the transmitting signal to the antenna of the antenna unit;
receiving, by the antenna unit, a base station signal wherein the received base station signal is combined to a self-interference signal to generate a combining signal;
adjusting, by the receiving unit, an amplitude and a phase of the transmitting signal to generate a sampling signal, and delaying, by the receiving unit, the combining signal so that the delayed combining signal is mixed to the sampling signal to cancel an interference component for transferring the receiving signal; and
demodulating, by the radio frequency transmitter/receiver, the receiving signal for transferring the receiving signal to the central processing unit.

14. The communication method of the co-frequency and co-time full duplex terminal for receiving and transmitting the signal using the common antenna of claim 13, wherein adjusting, by the receiving unit, an amplitude and a phase of the transmitting signal to generate a sampling signal, and delaying, by the receiving unit, the combining signal so that the delayed combining signal is mixed to the sampling signal to cancel an interference component for transferring the receiving signal, further comprising:
delaying, by the delay unit, the combining signal to generate a delay signal;
decaying, by the receiving unit, an amplitude of the transmitting signal to generate a decayed signal;
making, by the adjustable decaying unit, a phase shift of the decayed signal to generate a sampling signal;
mixing, by the adjustable phase shift unit, the sampling signal to the delay signal to cancel the self-interference signal to output the receiving signal; and
transferring, by the receiving unit, the receiving signal to the radio frequency transmitter/receiver.

15. The communication method of the co-frequency and co-time full duplex terminal for receiving and transmitting the signal using the common antenna of claim 14, wherein the amplitude of the sampling signal is the same as the amplitude of the self-interference signal, the phase of the sampling signal is inverse to the phase of the self-interference signal, and a phase difference between of the sampling signal and the self-interference signal is π.
